(19) United States
(12) Patent Application Publication
(10) Pub. No.: US 2024/0386042 A1
(43) Pub. Date: Nov. 21, 2024

(54) SYSTEM AND METHODS FOR ACCELERATING NATURAL LANGUAGE PROCESSING VIA INTEGRATION OF CASE-SPECIFIC AND GENERAL KNOWLEDGE

(71) Applicant: LAER AI, Inc., New York, NY (US)

(72) Inventor: Igor LABUTOV, New York, NY (US)

(73) Assignee: LAER AI, Inc., New York, NY (US)

(21) Appl. No.: 18/667,835

(22) Filed: May 17, 2024

Related U.S. Application Data
(60) Provisional application No. 63/503,341, filed on May 19, 2023.

(51) Int. Cl. G06F 16/332; G06F 16/35; G06F 40/205

(52) U.S. Cl. CPC G06F 16/3329; G06F 16/35; G06F 40/205

(57) ABSTRACT

A system and method for building predictive machine learning models. A method includes: parsing text of a document review protocol in order to extract at least one description of at least one concept to be tagged; tagging at least a portion of a plurality of documents in order to create a plurality of tagged documents by applying a language model to the plurality of documents, wherein tagging the at least a portion of the plurality of documents further comprises querying the language model using at least one query generated based on the extracted at least one description; constructing at least one classifier machine learning model based on the extracted at least one description; and training the at least one classifier machine learning model using a training set, wherein the training set includes the plurality of tagged documents.

### CROSS-REFERENCE TO RELATED APPLICATIONS

This application claims the benefit of U.S. Provisional Patent Application No. 63/503,341 filed on May 19, 2023, the contents of which are hereby incorporated by reference.

### TECHNICAL FIELD

The present disclosure relates to predictive machine learning, and more specifically to extracting knowledge and building predictive machine learning models for efficient document classification and review.

### BACKGROUND

Legal document review is a labor-intensive and time-consuming process that involves manual tagging of documents by human reviewers. Modern machine learning-based solutions, such as Technology Assisted Review (TAR) and Continuous Active Learning (CAL), require human reviewers to tag documents as examples for the machine to learn from. This process demands extensive time and resources and can take days, weeks, or months to complete. Further, the process can cost millions of dollars.

It would therefore be advantageous to provide a solution that would overcome the challenges noted above.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” or “certain embodiments” may be used herein to refer to a single embodiment or multiple embodiments of the disclosure.

Certain embodiments disclosed herein include a method for building predictive machine learning models. The method comprises: parsing text of a document review protocol in order to extract at least one description of at least one concept to be tagged; tagging at least a portion of a plurality of documents in order to create a plurality of tagged documents by applying a language model to the plurality of documents, wherein tagging the at least a portion of the plurality of documents further comprises querying the language model using at least one query generated based on the extracted at least one description; constructing at least one classifier machine learning model based on the extracted at least one description; and training the at least one classifier machine learning model using a training set, wherein the training set includes the plurality of tagged documents.

Certain embodiments disclosed herein also include a non-transitory computer readable medium having stored thereon causing a processing circuitry to execute a process, the process comprising: parsing text of a document review protocol in order to extract at least one description of at least one concept to be tagged; tagging at least a portion of a plurality of documents in order to create a plurality of tagged documents by applying a language model to the plurality of documents, wherein tagging the at least a portion of the plurality of documents further comprises querying the language model using at least one query generated based on the extracted at least one description; constructing at least one classifier machine learning model based on the extracted at least one description; and training the at least one classifier machine learning model using a training set, wherein the training set includes the plurality of tagged documents.

Certain embodiments disclosed herein also include a system for building predictive machine learning models. The system comprises: a processing circuitry; and a memory, the memory containing instructions that, when executed by the processing circuitry, configure the system to: parse text of a document review protocol in order to extract at least one description of at least one concept to be tagged; tag at least a portion of a plurality of documents in order to create a plurality of tagged documents by applying a language model to the plurality of documents, wherein tagging the at least a portion of the plurality of documents further comprises querying the language model using at least one query generated based on the extracted at least one description; construct at least one classifier machine learning model based on the extracted at least one description; and train the at least one classifier machine learning model using a training set, wherein the training set includes the plurality of tagged documents.

Certain embodiments disclosed herein include the method, non-transitory computer readable medium, or system noted above, further including or being configured to perform the following step or steps: determining a structure of the document review protocol; identifying the at least one concept to be tagged based on the structure of the document review protocol; and parsing out text indicating at least one rule for identifying the at least one concept to be tagged within the plurality of documents based on the structure of the document review protocol and the identified at least one concept to be tagged; and extracting the parsed out text.

Certain embodiments disclosed herein include the method, non-transitory computer readable medium, or system noted above, wherein the at least one concept to be tagged includes at least one case-specific concept indicated in the document review protocol.

Certain embodiments disclosed herein include the method, non-transitory computer readable medium, or system noted above, further including or being configured to perform the following step or steps: determining a score for each document of the plurality of documents based on the extracted at least one description of the at least one concept to be tagged, wherein the determined score for each document represents a likelihood that the document includes text indicating at a portion of the at least one concept to be tagged.

Certain embodiments disclosed herein include the method, non-transitory computer readable medium, or system noted above, further including or being configured to perform the following step or steps: updating the at least one classifier machine learning model based on feedback data until each of at least one performance metric for the at least one classifier model meets a respective performance threshold.

Certain embodiments disclosed herein include the method, non-transitory computer readable medium, or system noted above, wherein the feedback data includes at least one feedback tag for the plurality of documents.

Certain embodiments disclosed herein include the method, non-transitory computer readable medium, or system noted above, wherein the feedback data includes at least one feedback modification to the document review protocol.

Certain embodiments disclosed herein include the method, non-transitory computer readable medium, or system noted above, wherein each document of the at least a portion of the plurality of documents is tagged with a respective first tag, further including or being configured to perform the following step or steps: determining a second tag for each document of the at least a portion of the plurality of documents based on the at least one feedback modification to the document review protocol; identifying at least one first document to be reviewed from among the plurality of documents, wherein the second tag each first document is different from the first tag for the first document;

presenting the at least one first document to a user for review; and re-tagging the plurality of documents based on the review.

Certain embodiments disclosed herein include the method, non-transitory computer readable medium, or system noted above, further including or being configured to perform the following step or steps: iteratively determining a subset of the plurality of documents to be labeled based on user inputs and querying a user based on the subset of documents determined at each iteration, wherein the user provides the user inputs indicating labels based on the subset of documents queried at each iteration; and tagging the determined subset of documents based on the labels indicated in the user inputs.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a network diagram utilized to describe various disclosed embodiments.

FIG. 2 is a flowchart illustrating a method for building predictive machine learning models for efficient document classification and review according to an embodiment.

FIG. 3 is a schematic diagram of an artificial intelligence discovery assistant (AIDA) system according to an embodiment.

FIG. 4 is an example image utilized to illustrate identification of a relevant document in accordance with at least some disclosed embodiments.

FIG. 5 is an example image utilized to illustrate identification of a relevant document in accordance with at least some disclosed embodiments.

FIG. 6 is an example diagram illustrating a performance review of a system configured in accordance with certain disclosed embodiments.

### DETAILED DESCRIPTION

The disclosed embodiments include systems and methods for building predictive machine learning models for document classification. Various disclosed embodiments provide an efficient way to classify and review documents while significantly reducing the need for human tagging. In accordance with various disclosed embodiments, an artificial Intelligence (AI) Discovery Assistant (AIDA) is designed and adapted to deal with general world concepts (e.g., energy, automobile parts) and case-specific concepts (e.g., names or roles of people, organizations, case-specific facts) found in document review protocols. The disclosed embodiments may be utilized, for example, to assist in legal document review using the review protocol document, including its natural language content.

In an embodiment, a knowledge base of facts is extracted from a set of case data including names or roles of people, normalizing and linking different names to the same individual, and consolidating various facts across the data. Text of a document review protocol is parsed in order to determine the definitions of concepts to be tagged (e.g., different issues, responsiveness, privilege), and to parse out the specific rules or requirements of each section pursuant to each concept or issue. To this end, in a further embodiment, positive and negative descriptions are distinguished from each other within the text and structuring these descriptions into an internal machine representation.

In an embodiment, one or more classifiers are constructed based on the extracted and structured descriptions from the protocol to make probabilistic predictions across the entire collection of documents, scoring each document according to its likelihood of belonging to a given issue or category as described in the review protocol. The machine learning models may be continuously updated and improved for each category or issue based on additional modifications to the review protocol or explicit example tags applied to documents, e.g., tags provided via user inputs. This process may be iterated until performance of the model meets one or more performance targets (e.g., targets defined based on one or more performance metrics meeting respective thresholds). Documents whose tags or scores have changed are identified, and may be presented to a user for review.

One or more active learning techniques are utilized to identify documents to be tagged manually in order to improve predictive performance more quickly. That is, the active learning process may be performed in order to determine a subset of the documents which are to be tagged manually, thereby reducing the amount of manual tagging work as compared to tagging the entire set of documents manually without sacrificing performance of a model trained using the automatically tagged documents. The active learning may be an iterative supervised learning process in which a learning algorithm interactively queries a user for labels. More specifically, the learning algorithm may select a subset of samples (e.g., a subset of a set of documents) for labeling by the user, and query the user for labels to be used to tag those samples. Use of a learning algorithm to select a portion of the samples for user labeling allows for reducing the amount of manual labeling in order to label a training set including the samples.

In an embodiment, the case data is or includes a collection of documents. In an embodiment, the documents are a set of documents, with each document at least containing text. The documents may include text, text and meta-data, text and natives, combinations thereof, and the like. In a further embodiment, tags or categories are a binary categorization applied at document level. In yet a further embodiment, issues in document-review are tags or categories that are specifically relevant to litigation.

In an embodiment, responsiveness in litigation is defined based on a certain tag or category that is the most important or otherwise to be utilized for a particular use case (e.g., as determined based on one or more predetermined indicators of importance or otherwise based on inputs indicating that a tag or category is responsive) as compared to other tags or categories such that a document with a “responsive” or “responsiveness” tag is considered to be responsive for such a use case. As a non-limiting example, documents which are required by the court or the other side during litigation may be responsive such that those documents may be tagged as “responsive.”

In an embodiment, privilege in litigation is defined with respect to a certain tag or category that identifies documents to be withheld from being seen by the other side such that a “privileged” tag indicates that a document is privileged. As a non-limiting example, documents containing communications with an attorney or spouse may be privileged such that those documents may be tagged as “privileged.”

In an embodiment, a classifier is a machine-learning model trained to receive as inputs some data, e.g., a document including text, and to output a classification corresponding to a category or tag for the data. Any of the tags or categories may be associated with predetermined indicators such as, but not limited to, responsiveness, privilege, and the like.

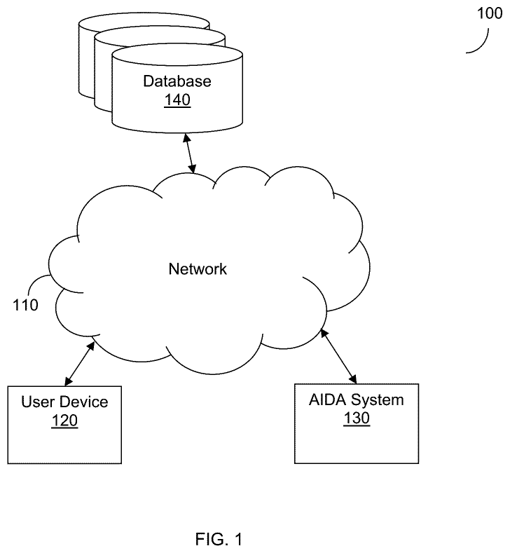

FIG. 1 shows an example network diagram 100 utilized to describe various disclosed embodiments. In the example network diagram 100, a user device 120, an artificial intelligence (AI) discovery assistant (AIDA) system 130, and a plurality of databases 140-1 through 140-N (hereinafter referred to individually as a database 140 and collectively as databases 140, merely for simplicity purposes) communicate via a network 110. The network 110 may be, but is not limited to, a wireless, cellular or wired network, a local area network (LAN), a wide area network (WAN), a metro area network (MAN), the Internet, the worldwide web (WWW), similar networks, and any combination thereof.

The user device 120 may be, but is not limited to, a personal computer, a laptop, a tablet computer, a smartphone, a wearable computing device, or any other device capable of receiving and displaying notifications. The user device 120 may receive electronic documents to be tagged, for example from the AIDA system 130, as well as inputs from a user (not shown) indicating tags to be assigned to those electronic documents.

The AIDA system 130 is configured to perform at least a portion of the disclosed embodiments. To this end, the AIDA system 130 may communicate with the user device 120, for example, in order to receive data (e.g., text or audio data) indicating document review protocols defining concepts to be tagged in accordance with various disclosed embodiments. More specifically, the AIDA system 130 is configured to train and utilize machine learning models as described herein in order to classify electronic documents based on review protocols. Further, as noted above, the AIDA system 130 may be configured to select a subset of a set of documents to be manually labeled, for example, by a user of the user device 120.

The databases 140 may store data such as, but not limited to, case data, electronic documents, both, and the like. Such case data may indicate, for example but not limited to, includes names or roles of people, normalizing and linking different names to the same individual, and consolidating various facts across the data.

It should be noted that the network diagram 100 illustrates an example environment in which various disclosed embodiments can be performed, but that the disclosed embodiments are not limited to the environment depicted in the network diagram 100. The various disclosed embodiments can be deployed in other environments without departing from the scope of the disclosure.

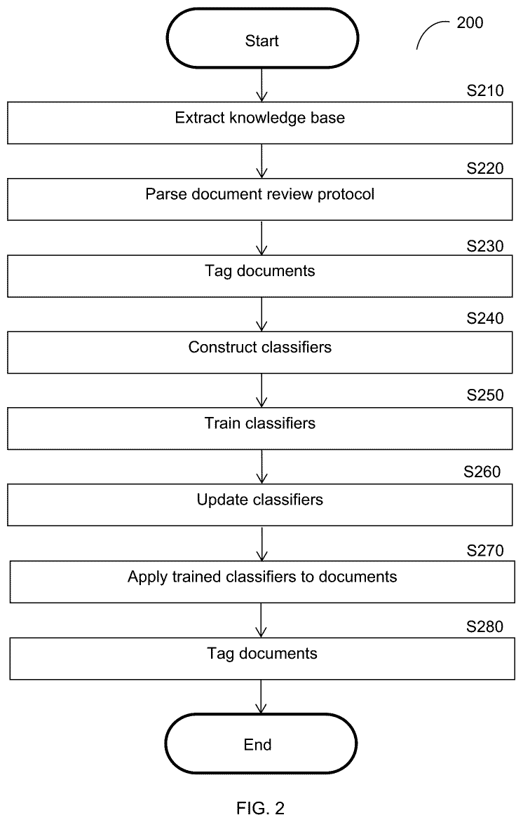

FIG. 2 is an example flowchart 200 illustrating a method for building predictive machine learning models for efficient document classification and review according to an embodiment. In an embodiment, the method is performed by the AIDA system 130, FIG. 1.

At S210, a knowledge base of facts from case data is extracted. In an embodiment, a knowledge base of facts is extracted from a set of case data including names or roles of people, normalizing and linking different names to the same individual, and consolidating various facts across the data. In this regard, the knowledge base of facts indicates case-specific information (e.g., specific entities involved in a given situation, entities having certain qualities, etc.) which may be the subject of a document review protocol. That is, the document review protocol may indicate concepts to be tagged for documents, and the knowledge base of facts may provide information about text which may be indicative of those concepts to be tagged.

In an embodiment, S210 includes applying a set of concept-identifying rules to the case data in order to identify portions of the case data indicating concepts represented in the case data. Such concept-identifying rules may define terms, phrases, grammatical structures, or other indicators of potential concepts. The concept-identifying rules may vary depending on the implementation. As a non-limiting example, concept-identifying rules for legal implementations may include rules for identifying concepts such as legal entities, individuals, legal documents (e.g., contracts), language suggesting legally relevant facts (e.g., language suggesting offer, acceptance, or consideration for a contract), combinations thereof, and the like.

At S220, text of a document review protocol is parsed. The parsing may be performed in order to identify and understand the definitions of concepts defined in the document review protocol. To this end, in an embodiment, the text is parsed in order to extract one or more descriptions of concepts to be tagged. In other words, the parsing is performed to identify structures describing how documents are to be tagged.

In an embodiment, parsing the document review protocol includes determining a structure of the document review protocol and identifying the concepts to be tagged within text of the document review protocol based on the structure. Text indicating rules for identifying the concepts to be tagged are parsed out from among the document review protocol based on the structure and the identified concepts. The parsed out text may be extracted for subsequent use.

More specifically, a structure of the document review protocol may be analyzed to identify which portions of the document review protocol include rules for identifying concepts, and the text to be parsed out may be text included in such portions including the rules based on the concepts to be tagged. To this end, portions of the document review protocol which, as determined based on the structure, contain such rules and which indicate one of the concepts to be tagged are parsed out. That is, the parsed out text includes text which indicates rules to be used for identifying the concepts to be tagged.

As a non-limiting example, the document review protocol may define certain concepts as privileged, may define certain concepts as responsive, both, and the like. Portions of data among the document review protocol corresponding to such definitions are parsed from other portions of data and extracted for use as definitions of concepts to be tagged during subsequent processing.

In a further embodiment, parsing the text of the document review protocol further includes distinguishing positive and negative descriptions from each other within the text and structuring these descriptions into an internal machine representation. The positive and negative descriptions may be identified accordingly, and such identifications of descriptions as positive or negative may be utilized, for example, in order to aid in tagging documents.

At S230, at least a portion of a set of documents is tagged in order to create a set of tagged documents. In an embodiment, the portion of the documents are tagged by applying a language model to the documents. In a further embodiment, tagging the portion of the documents includes querying a language model (e.g., a LLM) using one or more queries generated based on the extracted descriptions of concepts to be tagged and providing the documents to the language model. The language model returns outputs including document tags indicating which documents include text indicating the concepts to be tagged.

In some embodiments, at least some documents among the set of documents may be tagged based on user inputs. In such an embodiment, a learning model may be applied to the documents in order to determine a subset of the documents to be labeled based on user inputs. The user is queried with the determined subset of documents in order to present the subset of documents to the user (e.g., via the user device 120, FIG. 1), and user inputs indicating labels for the documents are received from the user.

In a further embodiment, an active learning method is utilized to identify documents for which manual tags are to be provided via user inputs over multiple iterations. In such an embodiment, the learning model may be applied at each iteration to the documents in order to determine a subset of the documents to be labeled and to query the user based on the subset of documents determined at that iteration. At each subsequent iteration after the first iteration, labels provided by the user via user inputs during a previous iteration are input to the learning model along with the documents. The learning model is trained to select documents for labeling based on the concepts to be tagged and such historical labels.

In this regard, the active learning process allows for iteratively labeling in a manner that reduces the amount of manual labeling and accelerating the labeling process. That is, the labels may be determined in iterations, with the learning model determining documents to be manually labeled at each iteration. Labels provided at previous iterations may be used during subsequent iterations to further identify which documents to label based on user inputs during those subsequent iterations, which allows for reducing the amount of documents which would otherwise be selected for manual labeling at each subsequent iteration. The result is a decrease in the overall number of documents which need to be manually labeled while achieving comparable or better performance of models trained using documents tagged using the labels determined at this step.

At S240, one or more classifier machine learning models (also referred to as classifiers) are constructed based on the extracted and structured descriptions from the protocol to make probabilistic predictions across the entire collection of documents. Each classifier is a machine learning model configured to output one or more classifications for an input document. To this end, each classifier may be configured to output a set of scores corresponding to respective classifications for a given document, where each score indicates a likelihood that its respective classification is accurate for the document. Accordingly, the scores may be utilized to determine one or more classifications for input documents.

In some embodiments, a classifier may be constructed for each potential concept among the knowledge base, and each such classifier may output a score representing a likelihood that the input document indicates the respective concept. In a further embodiment, when documents are to be tagged in accordance with a document review protocol, only a subset of the classifiers is applied to the documents. Such a subset of the classifiers may include classifiers which correspond to the concepts to be tagged extracted from the document review protocol.

In an embodiment, the classifiers are constructed in order to output scores for respective classifications corresponding to different concepts to be tagged. That is, each classification may correspond to one of the concepts to be tagged such that a score for that classification represents whether an input document belongs to or otherwise includes text related to the respective concept.

At S250, the classifier machine learning models are trained based on the tagged documents. In an embodiment, the classifiers are trained using a training set including a set of training inputs and a set of training outputs. The set of training inputs includes training documents or sets of training text of documents, and the training outputs include classifications for each of the training documents or sets of training document text. More specifically, for each tagged document, the document or text from the document may be utilized as a training input, and the classification indicated by the tag of the document is utilized as the training label for that input (i.e., the label representing the corresponding output).

At S260, the classifier machine learning models are updated and improved based on feedback data. In an embodiment, each classifier may be updated continuously, iteratively, or otherwise until one or more performance metrics meet respective performance thresholds. The feedback data may include, but is not limited to, feedback tags (e.g., tags provided as user inputs indicating a “correct” tag to be compared to the outputs of the classifiers), feedback modifications to the document review protocol (e.g., a new version of the document review protocol or portion thereof), both, and the like.

When the feedback data includes feedback tags, the feedback tags may be utilized to adjust weights of the applicable classifiers accordingly. To this end, in such an embodiment, the feedback tags may be used as labels for their respective documents during an additional iteration of training instead of the original tags used for a previous iteration of training, thereby causing the models to be updated based on this additional training using the feedback tags.

When the feedback data includes feedback modifications to the document review protocol, updating the classifier machine learning models may further include determining second new tags for the documents using concepts to be tagged extracted from a modified version of the document review protocol (i.e., a version including the modifications or otherwise the new version of the document review protocol). To this end, in such an embodiment, updating the classifiers may further include parsing the modified document review protocol in order to extract a new set of concepts to be tagged (e.g., using the process described above with respect to S220), and querying the language model with respect to the documents using queries generated based on the newly extracted concepts to be tagged and re-training the classifiers based on the outputs of the language model.

In a further embodiment, the new tags may be compared to the first previous tags in order to determine whether the new tag for each document is different from the previous tag for the document (i.e., whether the tag has changed after the modification to the document review protocol), and each document whose tag has changed may be presented to a user for review. The review may include the user manually reviewing each such document and providing a set of user inputs including manually created labels for the documents. The documents may be re-tagged based on the review, for example by re-tagging the documents with the labels provided by the user. This change detection and review may allow for correcting tags which may have been determined incorrectly using the language model in order to ensure the resulting model trained using the tagged documents performs adequately while still reducing the number of documents to be manually tagged.

At S270, the trained classifiers are applied. More specifically, the trained models are applied to one or more documents in order to determine classifications for those documents.

The models being applied are trained using at least some of the techniques discussed herein, which allows for training the model more efficiently and, at least in some embodiments, may achieve comparable or better performance with a lower amount of training data, particularly human-made tags, as compared to various existing solutions.

At optional S280, the documents to which the trained models were applied may be tagged using the classifications output by the models.

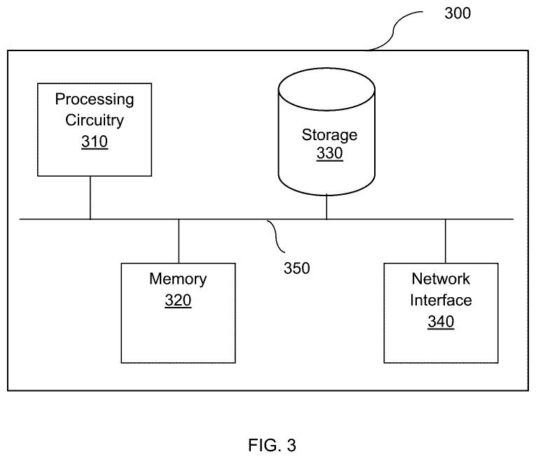

FIG. 3 is an example schematic diagram of a hardware layer 300 of an AIDA system such as the AIDA system 130 according to an embodiment. The hardware layer 300 includes a processing circuitry 310 coupled to a memory 320, a storage 330, and a network interface 340. In an embodiment, the components of the hardware layer 300 may be communicatively connected via a bus 350.

The processing circuitry 310 may be realized as one or more hardware logic components and circuits. For example, and without limitation, illustrative types of hardware logic components that can be used include field programmable gate arrays (FPGAs), application-specific integrated circuits (ASICs), Application-specific standard products (ASSPs), system-on-a-chip systems (SOCs), graphics processing units (GPUs), tensor processing units (TPUs), general-purpose microprocessors, microcontrollers, digital signal processors (DSPs), and the like, or any other hardware logic components that can perform calculations or other manipulations of information.

The memory 320 may be volatile (e.g., random access memory, etc.), non-volatile (e.g., read only memory, flash memory, etc.), or a combination thereof.

In one configuration, software for implementing one or more embodiments disclosed herein may be stored in the storage 330. In another configuration, the memory 320 is configured to store such software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the processing circuitry 310, cause the processing circuitry 310 to perform the various processes described herein.

The storage 330 may be magnetic storage, optical storage, and the like, and may be realized, for example, as flash memory or other memory technology, compact disk-read only memory (CD-ROM), Digital Versatile Disks (DVDs), or any other medium which can be used to store the desired information.

The network interface 340 allows the hardware layer 300 to communicate with, for example, the user device 120, the databases 140, and the like.

It should be understood that the embodiments described herein are not limited to the specific architecture illustrated in FIG. 3, and other architectures may be equally used without departing from the scope of the disclosed embodiments.

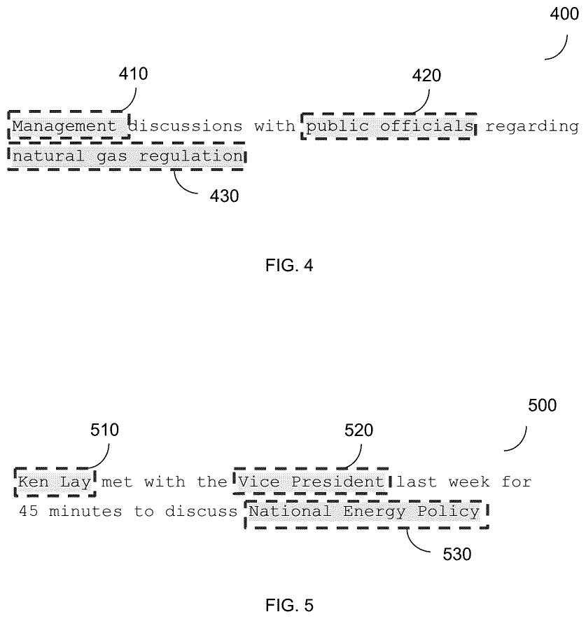

The disclosed embodiments provide benefits over certain solutions such as manual keyword searches and Tape Archiver (tar) tools including, but not limited to, efficiently providing responsive document snippets. Examples of such benefits as can be seen in non-limiting example FIG. 4 and FIG. 5, which illustrate example images 400 and 500, respectively, showing sample snippets. Specifically, FIG. 4 shows an image 400 of a document review protocol snippet defining responsiveness, and FIG. 5 shows an image 500 of a snippet from a document found to be responsive (e.g., by the AIDA system 130) in accordance with various disclosed embodiments.

As depicted in FIGS. 4 and 5, various key words or terms are highlighted as indicated by dash line boxes surrounding their respective text. In FIG. 4, the terms “management” 410, “public officials” 420, and “natural gas regulation” 430 are highlighted. In FIG. 5, the terms “Ken Lay” 510, “Vice President” 520, and “National Energy Policy” 530 are highlighted. The highlighted terms show related concepts utilized to identify that the document is responsive in accordance with various disclosed embodiments.

Despite the lack of shared words between the document and the review protocol snippets, an AIDA system (e.g., the AIDA system 130) is able to effectively identify the relevant document based on the protocol specification. In contrast, solutions like manual keyword searches and TAR tools may face additional challenges in identifying relevant documents.

Some existing solutions rely on learning from example documents, which means reviewers must tag numerous documents in order to train a machine learning model to identify relevant documents like the example portion of a relevant document shown in FIG. 5 (i.e., the document which is relevant insofar as it is responsive to the portion of the document shown in FIG. 4). These tools therefore lack the ability to bring external knowledge to bear on the problem and fail to effectively recognize individuals' roles or titles, requiring reviewers to tag even more examples to achieve sufficient coverage. The result is a high amount of manual tagging of samples to be used for training.

Moreover, analysts using a manual approach would have to perform laborious keyword searches to identify possible words connecting the document snippet to the responsiveness requirement in the review protocol. This process is time-consuming, expensive, and error-prone, as it involves exhaustive searches with numerous keywords and relies on potentially incomplete lists of people and their roles. Further, this process often involves many subjective judgments on behalf of the analysts. As a result, this manual process can result in a set of tagged documents which varies greatly between manual reviewers.

The disclosed embodiments allow for overcoming at least these challenges. In particular, such challenges may be overcome at least in part by parsing the complete document collection to extract structured knowledge and utilizing a Large Language Model (LLM) to understand general concepts like “energy” without the need for reviewers to manually tag multiple examples covering the topic. More specifically, the extracted structured knowledge may be or may include case-specific entities like people and organizations, along with their relationships, including roles and titles. Identifying these case-specific entities allows for recognizing, via machine learning, management individuals based on the document review protocol, without requiring manual tagging of examples.

The combination of structured case-specific knowledge and general knowledge from the LLM in accordance with various disclosed embodiments enables the system to leverage descriptions in the document review protocol to identify relevant documents without any human-tagged examples or otherwise with a reduced number of human-tagged examples. This reduces the amount of manual review, as well as potential inconsistencies between manual reviewers caused by accumulated differences in subjective judgments.

Accordingly, various disclosed embodiments reduce the amount of human review tags while achieving the same or better performance (e.g., in terms of precision or recall) compared to at least some existing solutions. By building an initial model directly from the review protocol, at least some disclosed embodiments accelerate the review process, leading to reduced costs and time. Moreover, various disclosed embodiments overcome a challenge in the form of the cold-start problem faced by existing machine learning solutions, providing the active learning system with enough information to identify the right examples for human tagging and subsequently improving predictive performance.

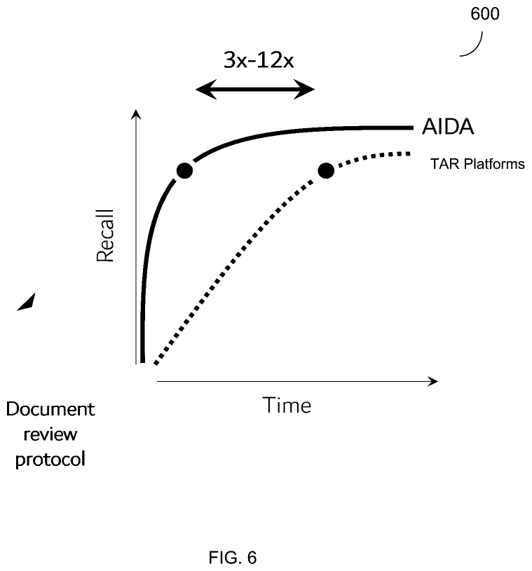

FIG. 6 is an example illustration 600 further showing benefits in efficiency of at least some disclosed embodiments. To assess the effectiveness of AIDA, a comprehensive evaluation was conducted using a benchmark set of 5 cases provided by a law firm. The performance of AIDA was compared head-to-head against both manual review and certain existing solutions for TAR systems.

As depicted in FIG. 6, the evaluation focused on comparing the number of human-reviewed documents required for each system, including AIDA, to reach a target performance level in precision and recall. This metric was chosen as a key indicator of efficiency and effectiveness in the document review process, as reducing the number of documents needing human review can significantly decrease the time and cost of the review process.

The results of the evaluation demonstrated improved performance of an AIDA system configured in accordance with at least some disclosed embodiments in comparison to existing automated and manual solutions. In some non-limiting example implementations, AIDA was shown to require between ⅓ to 1/12 less data, in terms of human-reviewed documents, as compared to certain existing solutions. This substantial reduction in the amount of human-reviewed documents in order to achieve comparable or better performance highlights the effectiveness of AIDA's approach, which combines structured case-specific knowledge extraction and general knowledge from a Large Language Model to better identify relevant documents based on the document review protocol.

The evaluation confirms that AIDA may be utilized to improve efficiency as compared to both traditional manual review methods as well as existing solutions for TAR systems, making it a highly effective and efficient solution for the document review process in legal settings.

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

The various embodiments disclosed herein can be implemented as hardware, firmware, software, or any combination thereof. Moreover, the software may be implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

It should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to first and second elements does not mean that only two elements may be employed there or that the first element must precede the second element in some manner. Also, unless stated otherwise, a set of elements comprises one or more elements.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; 2A; 2B; 2C; 3A; A and B in combination; B and C in combination; A and C in combination; A, B, and C in combination; 2A and C in combination; A, 3B, and 2C in combination; and the like.

What is claimed is:

1. A method for building predictive machine learning models, comprising:
parsing text of a document review protocol in order to extract at least one description of at least one concept to be tagged;
tagging at least a portion of a plurality of documents in order to create a plurality of tagged documents by applying a language model to the plurality of documents, wherein tagging the at least a portion of the plurality of documents further comprises querying the language model using at least one query generated based on the extracted at least one description;
constructing at least one classifier machine learning model based on the extracted at least one description; and
training the at least one classifier machine learning model using a training set, wherein the training set includes the plurality of tagged documents.

2. The method of claim 1, wherein parsing the document review protocol further comprises:
determining a structure of the document review protocol;
identifying the at least one concept to be tagged based on the structure of the document review protocol; and
parsing out text indicating at least one rule for identifying the at least one concept to be tagged within the plurality of documents based on the structure of the document review protocol and the identified at least one concept to be tagged; and
extracting the parsed out text.

3. The method of claim 1, wherein the at least one concept to be tagged includes at least one case-specific concept indicated in the document review protocol.

4. The method of claim 1, further comprising:
determining a score for each document of the plurality of documents based on the extracted at least one description of the at least one concept to be tagged, wherein the determined score for each document represents a likelihood that the document includes text indicating at a portion of the at least one concept to be tagged.

5. The method of claim 1, further comprising:
updating the at least one classifier machine learning model based on feedback data until each of at least one performance metric for the at least one classifier machine learning model meets a respective performance threshold.

6. The method of claim 5, wherein the feedback data includes at least one feedback tag for the plurality of documents.

7. The method of claim 5, wherein the feedback data includes at least one feedback modification to the document review protocol.

8. The method of claim 7, wherein each document of the at least a portion of the plurality of documents is tagged with a respective first tag, further comprising:
determining a second tag for each document of the at least a portion of the plurality of documents based on the at least one feedback modification to the document review protocol;
identifying at least one first document to be reviewed from among the plurality of documents, wherein the second tag each first document is different from the first tag for the first document;
presenting the at least one first document to a user for review; and
re-tagging the plurality of documents based on the review.

9. The method of claim 1, further comprising
iteratively determining a subset of the plurality of documents to be labeled based on user inputs and querying a user based on the subset of documents determined at each iteration, wherein the user provides the user inputs indicating labels based on the subset of documents queried at each iteration; and
tagging the determined subset of documents based on the labels indicated in the user inputs.

10. A non-transitory computer readable medium having stored thereon instructions for causing a processing circuitry to execute a process, the process comprising:
parsing text of a document review protocol in order to extract at least one description of at least one concept to be tagged;
tagging at least a portion of a plurality of documents in order to create a plurality of tagged documents by applying a language model to the plurality of documents, wherein tagging the at least a portion of the plurality of documents further comprises querying the language model using at least one query generated based on the extracted at least one description;
constructing at least one classifier machine learning model based on the extracted at least one description; and
training the at least one classifier machine learning model using a training set, wherein the training set includes the plurality of tagged documents.

11. A system for assisting in legal document review using artificial intelligence, comprising:
a processing circuitry; and
a memory, the memory containing instructions that, when executed by the processing circuitry, configure the system to:
parse text of a document review protocol in order to extract at least one description of at least one concept to be tagged;
tag at least a portion of a plurality of documents in order to create a plurality of tagged documents by applying a language model to the plurality of documents, wherein tagging the at least a portion of the plurality of documents further comprises querying the language model using at least one query generated based on the extracted at least one description;
construct at least one classifier machine learning model based on the extracted at least one description; and
train the at least one classifier machine learning model using a training set, wherein the training set includes the plurality of tagged documents.

12. The system of claim 11, wherein the system is further configured to:
determine a structure of the document review protocol;
identify the at least one concept to be tagged based on the structure of the document review protocol; and
parse out text indicating at least one rule for identifying the at least one concept to be tagged within the plurality of documents based on the structure of the document review protocol and the identified at least one concept to be tagged; and
extract the parsed out text.

13. The system of claim 11, wherein the at least one concept to be tagged includes at least one case-specific concept indicated in the document review protocol.

14. The system of claim 11, wherein the system is further configured to:
determine a score for each document of the plurality of documents based on the extracted at least one description of the at least one concept to be tagged, wherein the determined score for each document represents a likelihood that the document includes text indicating at a portion of the at least one concept to be tagged.

15. The system of claim 11, wherein the system is further configured to:
update the at least one classifier machine learning model based on feedback data until each of at least one performance metric for the at least one classifier machine learning model meets a respective performance threshold.

16. The system of claim 15, wherein the feedback data includes at least one feedback tag for the plurality of documents.

17. The system of claim 15, wherein the feedback data includes at least one feedback modification to the document review protocol.

18. The system of claim 17, wherein each document of the at least a portion of the plurality of documents is tagged with a respective first tag, wherein the system is further configured to:
determine a second tag for each document of the at least a portion of the plurality of documents based on the at least one feedback modification to the document review protocol;
identify at least one first document to be reviewed from among the plurality of documents, wherein the second tag each first document is different from the first tag for the first document;
present the at least one first document to a user for review; and
re-tag the plurality of documents based on the review.

19. The system of claim 11, wherein the system is further configured to:
iteratively determine a subset of the plurality of documents to be labeled based on user inputs and querying a user based on the subset of documents determined at each iteration, wherein the user provides the user inputs indicating labels based on the subset of documents queried at each iteration; and
tag the determined subset of documents based on the labels indicated in the user inputs.
